(19) United States
(12) Patent Application Publication
(10) Pub. No.: US 2024/0386319 A1
(43) Pub. Date: Nov. 21, 2024

(54) PREDICTION APPARATUS, LEARNING APPARATUS, PREDICTION METHOD, LEARNING METHOD AND PROGRAM

(71) Applicant: NIPPON TELEGRAPH AND TELEPHONE CORPORATION, Tokyo (JP)

(72) Inventors: Shuhei YAMAMOTO, Tokyo (JP); Takeshi KURASHIMA, Tokyo (JP); Hiroyuki TODA, Tokyo (JP); Tomu TOMINAGA, Tokyo (JP)

(21) Appl. No.: 18/557,158

(22) PCT Filed: May 28, 2021
(86) PCT No.: PCT/JP2021/020539

§ 371 Date: Oct. 25, 2023

(51) Int. Cl. G06N 20/00; G06F 18/25

(52) U.S. Cl. CPC G06N 20/00; G06F 18/253

(57) ABSTRACT

Provided is a prediction apparatus including a feature extraction unit configured to extract a feature based on past behavior series data of a prediction target and output behavior feature data, a behavior series prediction unit configured to predict a future behavior series of the prediction target based on the behavior feature data using a trained behavior series prediction model for predicting a behavior series, and a mood series prediction unit configured to predict a future mood series of the prediction target based on the behavior feature data and past mood series data of the prediction target using a trained mood series prediction model for predicting a mood series.

### TECHNICAL FIELD

The present invention relates to a prediction apparatus, a learning apparatus, a prediction method, a learning method, and a program.

### BACKGROUND ART

With the spread of wearable sensors represented by smart watches, fitness trackers, smartphones, and the like, it has become possible to easily record users' biometric information and behavior logs (hereinafter referred to as behavior data). Detailed analysis of the behavior data and psychological states (such as the degrees of mood, emotion, and stress) obtained by users' self-evaluation is useful for various purposes. For example, when it is possible to estimate today's degree of stress as a numerical value or to predict a future mood using a history of user behavior data acquired through a smart watch, it will be useful for various purposes such as recommendation of behavior effective in improving the user's psychological state.

For example, NPL 1 discloses a technique of automatically estimating a user's psychological state from such behavior data, or a technique of discretizing obtained data, converting the data into a histogram, and estimating the degree of health or the degree of stress using a probabilistic generative model. In addition, NPL 2 discloses a technique of regressing the next day's psychological state using daily series data of operation logs and screen time acquired from a smartphone. In addition, NPL 3 discloses a technique of predicting a series of future mood data from a series of past behavior data.

### CITATION LIST

### Non Patent Literature

NPL 1: E. Nosakhare and R. Picard: Probabilistic Latent Variable Modeling for Assessing Behavioral Influences on Well-Being. In Proc. of KDD, 2019.
NPL 2: S. Yan et al.: Estimating Individualized Daily Self-Reported Affect with Wearable Sensors. In Proc. of ICHI, 2019.
NPL 3: D. Spathis, S. Servia-Rodriguez, K. Farrahi, C. Mascolo, and J. Rentflow: Sequence Multi-task Learning to Forecast Mental Wellbeing from Sparse Self-reported Data. In Proc. of KDD, 2019.

### SUMMARY OF INVENTION

### Technical Problem

Incidentally, in the past, since data was statistically processed in units of days, it was not possible to consider time-series fluctuations in a user's mood or emotion depending on the date and time. For example, in the method disclosed in NPL 2, mood data posted many times a day is quantified and converted into an average value, and then the average value of mood for the next day is predicted. However, since human mood rises and falls throughout the day, predicting the average value alone is not enough to present fluctuations in mood to the user.

In addition, the method disclosed in NPL 3 does not allow consideration of the influence of one's actions in the future. For example, in a case where a user puts off an action that is unfavorable for him/her (such as a negative event) until the next day, it is thought that some users will be influenced by it and feel negative. Therefore, the techniques of the related art have difficulty in predicting time-series fluctuations in future mood.

An object of the disclosed technique is to predict time-series fluctuations in the future mood of a prediction target.

### Solution to Problem

According to the disclosed technique, there is provided a prediction apparatus including: a feature extraction unit configured to extract a feature based on past behavior series data of a prediction target and output behavior feature data; a behavior series prediction unit configured to predict a future behavior series of the prediction target based on the behavior feature data using a trained behavior series prediction model for predicting a behavior series; and a mood series prediction unit configured to predict a future mood series of the prediction target based on the behavior feature data and past mood series data of the prediction target using a trained mood series prediction model for predicting a mood series.

### Advantageous Effects of Invention

It is possible to predict time-series fluctuations in the future mood of a prediction target.

### BRIEF DESCRIPTION OF DRAWINGS

FIG. 1 is a functional configuration diagram of a learning apparatus.

FIG. 2 is a functional configuration diagram of a prediction apparatus.

FIG. 3 is a flowchart illustrating an example of a flow of a learning process.

FIG. 4 is a flowchart illustrating an example of a flow of a prediction process.

FIG. 5 is a diagram illustrating an example of behavior series data.

FIG. 6 is a diagram illustrating an example of preprocessed behavior feature data.

FIG. 7 is a diagram illustrating an example of mood series data.

FIG. 8 is a diagram illustrating an example of preprocessed mood series data.

FIG. 9 is a flowchart illustrating an example of a flow of behavior data preprocessing.

FIG. 10 is a flowchart illustrating an example of a flow of a feature extraction process.

FIG. 11 is a flowchart illustrating an example of a flow of mood data preprocessing.

FIG. 12 is a diagram illustrating an example of a behavior series prediction model.

FIG. 13 is a flowchart illustrating an example of a flow of a behavior series prediction model learning process.

FIG. 14 is a diagram illustrating an example of a behavior series prediction model DB and a mood series prediction model DB.

FIG. 15 is a diagram illustrating an example of a mood series prediction model.

FIG. 16 is a flowchart illustrating an example of a flow of a mood series prediction model learning process.

FIG. 17 is a flowchart illustrating an example of a flow of a behavior series prediction process.

FIG. 18 is a flowchart illustrating an example of a flow of a mood series prediction process.

FIG. 19 is a diagram illustrating a hardware configuration example of a computer.

### DESCRIPTION OF EMBODIMENTS

Hereinafter, an embodiment (present embodiment) of the present invention will be described with reference to the accompanying drawings. An embodiment to be described below is only an example, and an embodiment to which the present disclosure is applied is not limited to the following embodiment.

### Outline of the Present Embodiment

A prediction apparatus according to the present embodiment extracts features from behavior data of a prediction target (such as a person or an animal), predicts a behavior series using a behavior series prediction model, and outputs future mood series data of the prediction target using a mood series prediction model based on the predicted behavior series and past mood data.

Behavior series data is data indicating time-series fluctuations in behavior. In addition, mood series data is data indicating time-series fluctuations in mood.

In addition, a learning apparatus according to the present embodiment updates parameters of the behavior series prediction model and the mood series prediction model through machine learning based on data for learning including behavior data, mood data, and the like of a learning target (such as a person or an animal).

### (Functional Configuration Example of Learning Apparatus)

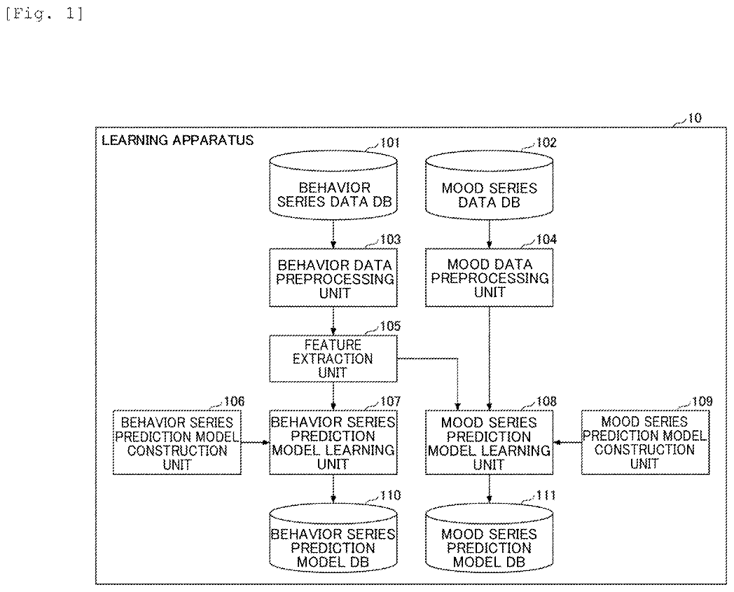

FIG. 1 is a functional configuration diagram of a learning apparatus. A learning apparatus 10 includes a behavior series data DB 101, a mood series data DB 102, a behavior data preprocessing unit 103, a mood data preprocessing unit 104, a feature extraction unit 105, a behavior series prediction model construction unit 106, a behavior series prediction model learning unit 107, a mood series prediction model learning unit 108, a mood series prediction model construction unit 109, a behavior series prediction model DB 110, and a mood series prediction model DB 111.

The behavior series data DB 101 stores behavior series data. The behavior series data is data indicating the past behavior of a learning target in time series. A specific example of the behavior series data will be described later.

The mood series data DB 102 stores mood series data. The mood series data is data indicating the past mood of a learning target in time series. A specific example of the mood series data will be described later.

The behavior series data DB 101 and the mood series data DB 102 are constructed in advance such that they can be associated with each other according to information on a date and time of data recording. In addition, the mood series data DB 102 stores two types of numerical values, valence and arousal, indicating the mood at the time of report as self-reported by a learning target. Here, the valence indicates the degree of positivity or negativity of emotion at that time. In addition, the arousal indicates the degree of excitement of emotion.

The mood series data configured in this way may be reported by a user using a known technique such as, for example, Photographic Affect Meter (PAM) (Reference Document [1]). For a process of constructing the mood series data DB 102, for example, the self-evaluation result of mood may be input by a target user, and the input result may be stored in a database.

The behavior data preprocessing unit 103 performs preprocessing on the behavior series data of a learning target. Specifically, the behavior data preprocessing unit 103 extracts behavior series data of a type designated in advance from the behavior series data of the learning target, scans a series of each piece of extracted behavior series data, and replaces missing values or unexpected values (when included) with other values. Meanwhile, in a case where preprocessing is unnecessary, the behavior data preprocessing unit 103 may not perform preprocessing.

The mood data preprocessing unit 104 performs preprocessing on the mood series data of the learning target. Specifically, the mood data preprocessing unit 104 aggregates data for each data group obtained by dividing the mood series data of the learning target for each time range designated in advance. Meanwhile, in a case where preprocessing is unnecessary, the mood data preprocessing unit 104 may not perform preprocessing.

The feature extraction unit 105 aggregates data for each data group obtained by dividing the preprocessed behavior series data for each time range designated in advance, and uses the aggregated data as behavior feature data.

The behavior series prediction model construction unit 106 uses the behavior feature data as an input to construct a behavior series prediction model for outputting the mean and variance of the predicted behavior series data.

The behavior series prediction model learning unit 107 updates parameters of the behavior series prediction model through machine learning.

The mood series prediction model learning unit 108 updates parameters of the mood series prediction model through machine learning.

The mood series prediction model construction unit 109 uses the behavior feature data, the predicted behavior series data, and the preprocessed mood series data as inputs to construct a mood series prediction model for outputting the predicted mood series data.

The behavior series prediction model DB 110 stores the behavior series prediction model together with parameters. The behavior series prediction model DB 110 is an example of a behavior series prediction model storage unit that stores the behavior series prediction model.

The mood series prediction model DB 111 stores the mood series prediction model together with parameters. The mood series prediction model DB 111 is an example of a mood series prediction model storage unit that stores the mood series prediction model.

### (Functional Configuration Example of Prediction Apparatus)

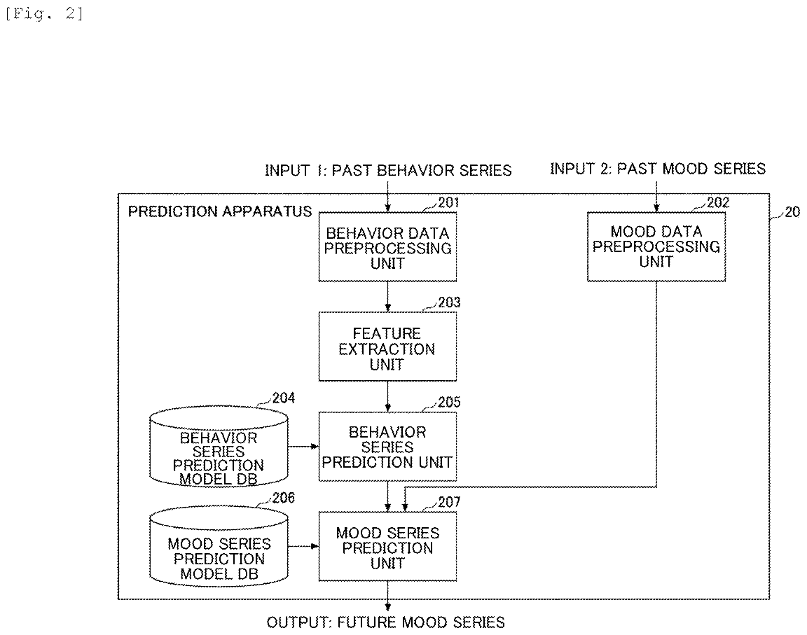

FIG. 2 is a functional configuration diagram of a prediction apparatus. A prediction apparatus 20 includes a behavior data preprocessing unit 201, a mood data preprocessing unit 202, a feature extraction unit 203, a behavior series prediction model DB 204, a behavior series prediction unit 205, a mood series prediction model DB 206, and a mood series prediction unit 207.

The behavior data preprocessing unit 201 performs substantially the same processing as the behavior data preprocessing unit 103 of the learning apparatus 10 on the past behavior series data of the prediction target. That is, the behavior data preprocessing unit 201 extracts behavior series data of a type designated in advance from the past behavior series data of the prediction target, scans a series of each piece of extracted behavior series data, and replaces missing values or unexpected values (when included) with other values.

The mood data preprocessing unit 202 performs substantially the same processing as the mood data preprocessing unit 104 of the learning apparatus 10 on past mood series data of the prediction target. That is, the mood data preprocessing unit 202 aggregates data for each data group obtained by dividing the past mood series data of the prediction target for each time range designated in advance.

The feature extraction unit 203 performs substantially the same processing as the feature extraction unit 105 of the learning apparatus 10. That is, the feature extraction unit 203 aggregates data for each data group obtained by dividing the preprocessed behavior series data for each time range designated in advance, and uses the aggregated data as behavior feature data.

The behavior series prediction model DB 204 stores the behavior series prediction model constructed by the behavior series prediction model construction unit 106 of the learning apparatus 10 together with parameters. The parameters to be stored are parameters updated by the behavior series prediction model learning unit 107 of the learning apparatus 10.

The behavior series prediction unit 205 predicts a future behavior series of the prediction target based on the behavior feature data using the behavior series prediction model.

The mood series prediction model DB 206 stores the mood series prediction model constructed by the mood series prediction model construction unit 109 of the learning apparatus 10 together with parameters. The parameters to be stored are parameters updated by the mood series prediction model learning unit 108 of the learning apparatus 10.

The mood series prediction unit 207 predicts a future mood series of the prediction target based on the behavior feature data and the preprocessed mood series data using the mood series prediction model.

### (Operation Example of Learning Apparatus)

Next, an operation example of the learning apparatus 10 will be described with reference to the accompanying drawings. The learning apparatus 10 starts a learning process in response to a user's operation or the like or periodically.

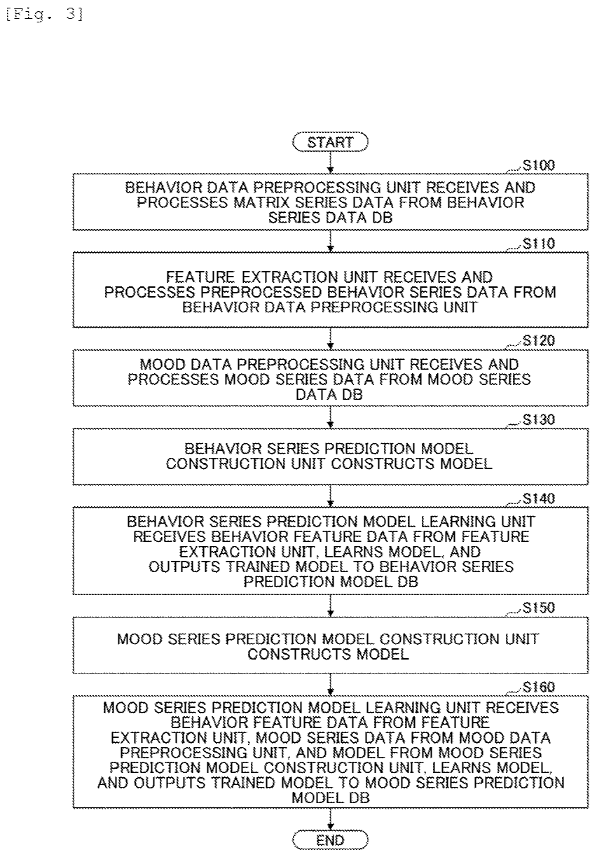

FIG. 3 is a flowchart illustrating an example of a flow of a learning process. The behavior data preprocessing unit 103 receives and processes the behavior series data from the behavior series data DB 101 (step S100). Next, the feature extraction unit 105 receives and processes the preprocessed behavior series data from the behavior data preprocessing unit 103 (step S110).

Subsequently, the mood data preprocessing unit 104 receives and processes the mood series data from the mood series data DB 102 (step S120). Next, the behavior series prediction model construction unit 106 constructs the behavior series prediction model (step S130). Subsequently, the behavior series prediction model learning unit 107 receives the behavior feature data from the feature extraction unit 105, learns the behavior series prediction model, and outputs a trained behavior series prediction model to the behavior series prediction model DB 110 (step S140).

Next, the mood series prediction model construction unit 109 constructs the mood series prediction model (step S150). The mood series prediction model learning unit 108 receives the behavior feature data from the feature extraction unit 105, the preprocessed mood series data from the mood data preprocessing unit 104, and the mood series prediction model from the mood series prediction model construction unit 109, learns the mood series prediction model, and outputs a trained mood series prediction model to the mood series prediction model DB 111 (step S160).

### (Operation Example of Prediction Apparatus)

Next, an operation example of the prediction apparatus 20 will be described with reference to the accompanying drawings. The prediction apparatus 20 starts a prediction process in response to a user's operation or the like or periodically.

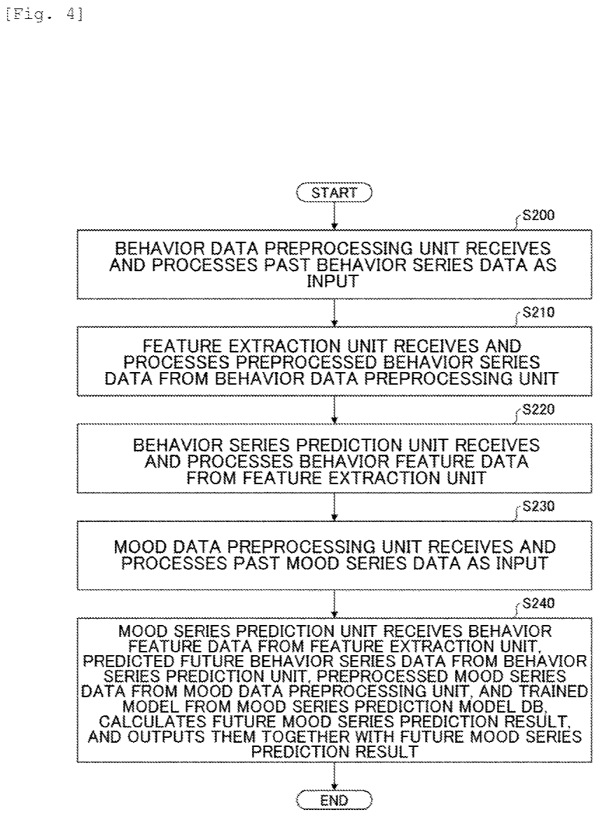

FIG. 4 is a flowchart illustrating an example of a flow of a prediction process. The behavior data preprocessing unit 201 receives and processes past behavior series data of the prediction target as an input (step S200). Next, the feature extraction unit 203 receives and processes the preprocessed behavior series data from the behavior data preprocessing unit 201 (step S210).

Subsequently, the behavior series prediction unit 205 receives and processes the behavior feature data from the feature extraction unit 203 (step S220). Next, the mood data preprocessing unit 202 receives and processes past mood series data of the prediction target as an input (step S230).

The mood series prediction unit 207 then receives the behavior feature data from the feature extraction unit 203, the predicted future behavior series data from the behavior series prediction unit 205, the preprocessed mood series data from the mood data preprocessing unit 202, and the trained mood series prediction model from the mood series prediction model DB, calculates a future mood series prediction result, and outputs them together with the future mood series prediction result (step S240).

### (Format Examples of Various Types of Data According to the Present Embodiment)

Next, format examples of various types of data handled by the learning apparatus 10 and the prediction apparatus 20 according to the present embodiment will be described.

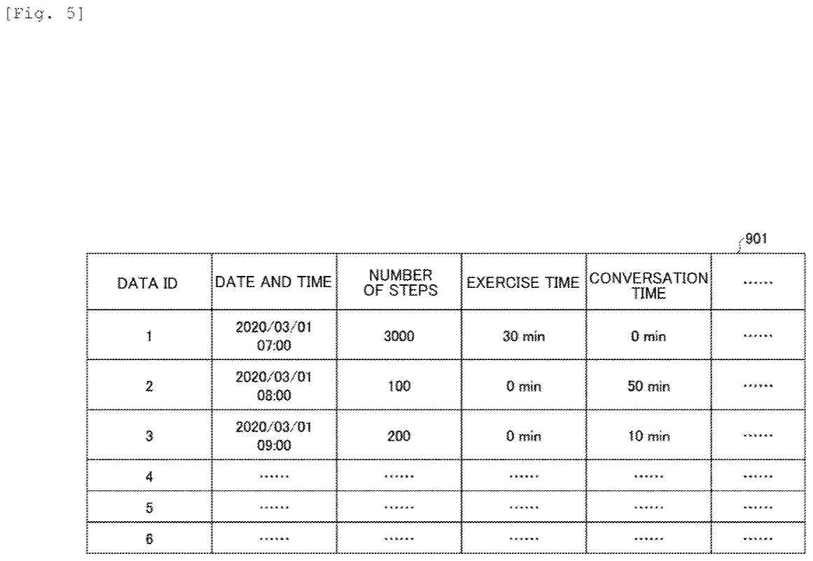

FIG. 5 is a diagram illustrating an example of behavior series data. Behavior series data 901 includes, as items, data ID, date and time, the number of steps, exercise time, and conversation time.

The value of the item “data ID” is an identifier for identifying each data record. The value of the item “date and time” is a value indicating the date and time when the behavior was performed. The item “number of steps,” the item “exercise time,” and the item “conversation time” are examples of items indicating the content of behavior. These items may be other items.

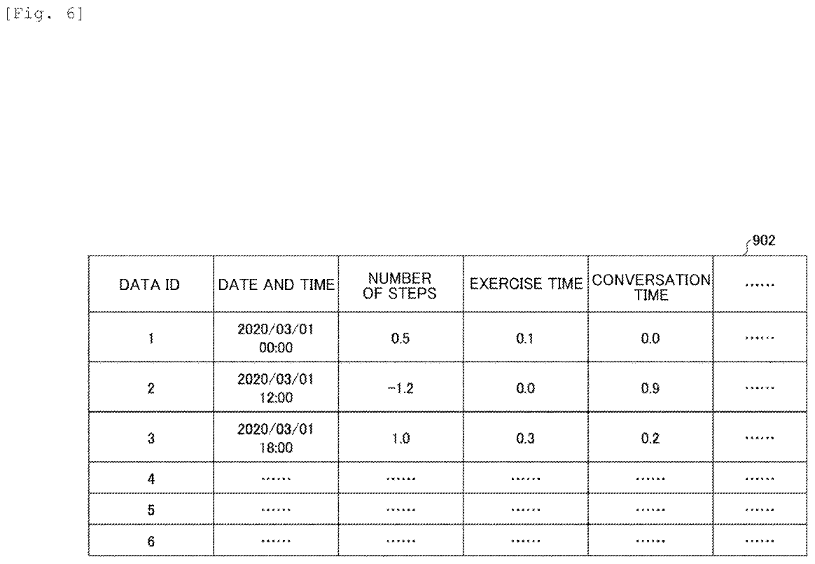

FIG. 6 is a diagram illustrating an example of preprocessed behavior feature data. Behavior feature data 902 includes, as items, data ID, date and time, the number of steps, exercise time, and conversation time.

The value of the item “data ID” is an identifier for identifying each data record. The value of the item “date and time” is a value indicating the starting point of a time range designated in advance by a system administrator. The item “number of steps,” the item “exercise time,” and the item “conversation time” are examples of items indicating the content of behavior. These items may be other items. Each value of the item “number of steps,” the item “exercise time,” and the item “conversation time” is a feature indicating the feature of each behavior through statistical processing based on normalized values.

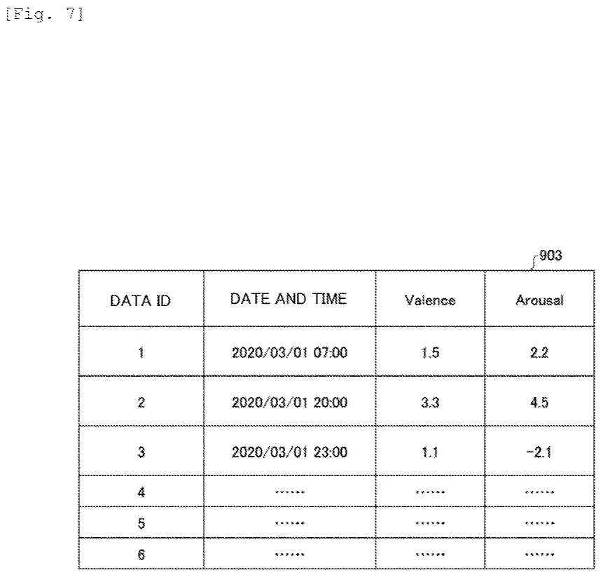

FIG. 7 is a diagram illustrating an example of mood series data. Mood series data 903 includes, as items, data ID, date and time, Valence, and Arousal.

The value of the item “data ID” is an identifier for identifying each data record. The value of the item “date and time” is a value indicating the date and time when the mood was reported. The item “Valence” and the item “Arousal” are examples of items indicating mood. These items may be other items. Each value of the item “Valence” and the item “Arousal” is a score self-reported by a learning target or prediction target user or the like.

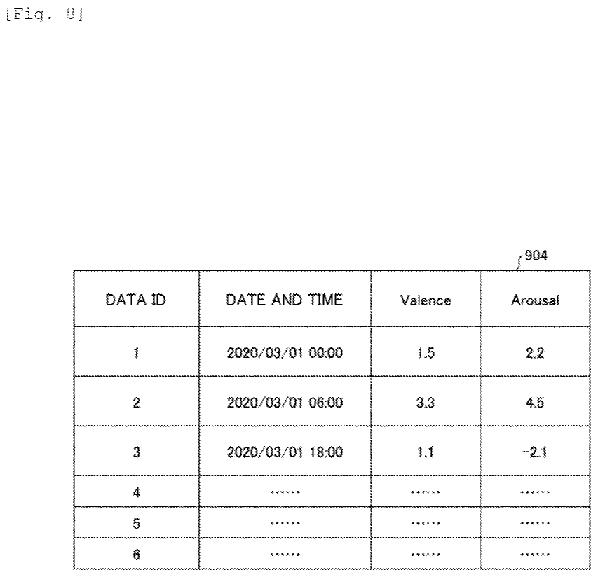

FIG. 8 is a diagram illustrating an example of preprocessed mood series data. Preprocessed mood series data (mood data) 904 includes, as items, data ID, date and time, Valence, and Arousal.

The value of the item “data ID” is an identifier for identifying each data record. The value of the item “date and time” is a value indicating the starting point of a time range designated in advance by a system administrator. The item “Valence” and the item “Arousal” are examples of items indicating mood. These items may be other items. Each value of the item “Valence” and the item “Arousal” is the average value of scores in each time range.

### (Details of Each Process According to the Present Embodiment)

Next, the details of the learning process and the prediction process according to the present embodiment will be described.

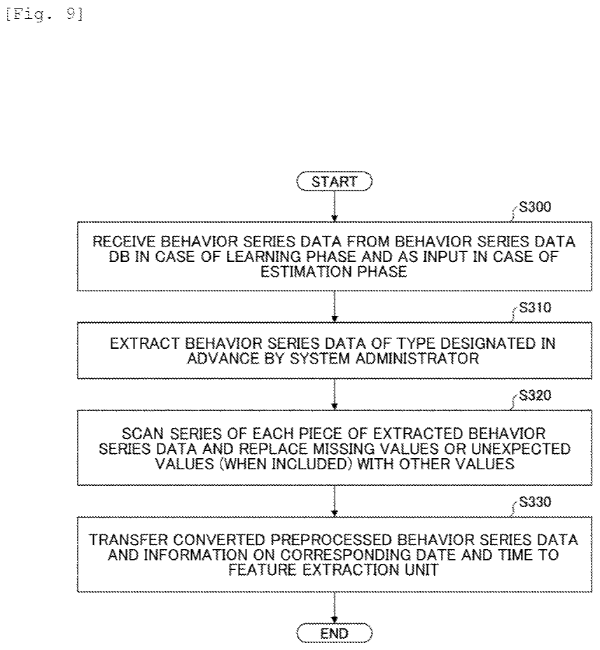

FIG. 9 is a flowchart illustrating an example of a flow of behavior data preprocessing. The behavior data preprocessing is processing performed by the behavior data preprocessing unit 103 in step S100 of the learning process or processing performed by the behavior data preprocessing unit 201 in step S200 of the prediction process.

In the case of a learning phase, the behavior data preprocessing unit 103 receives behavior series data from the behavior series data DB 101 (step S300). Meanwhile, in the case of a prediction phase, the behavior data preprocessing unit 201 receives behavior series data as an input.

Next, the behavior data preprocessing unit 103 or the behavior data preprocessing unit 201 extracts behavior series data of a type designated in advance by a system administrator (step S310). For example, the behavior data preprocessing unit 103 or the behavior data preprocessing unit 201 defines the series names of behavior series data to be extracted, and extracts data of the series that matches the series names.

Subsequently, the behavior data preprocessing unit 103 or the behavior data preprocessing unit 201 scans the series of each piece of extracted behavior series data and replaces missing values or unexpected values (when included) with other values (step S320). For example, the behavior data preprocessing unit 103 or the behavior data preprocessing unit 201 inserts the average value of the corresponding series or 0 in the case of numerical data, and a character string representing a missing value in the case of character string type data.

Subsequently, the behavior data preprocessing unit 103 or the behavior data preprocessing unit 201 transfers the converted preprocessed behavior series data and information on the corresponding date and time to the feature extraction unit 105 or the feature extraction unit 203 (step S330).

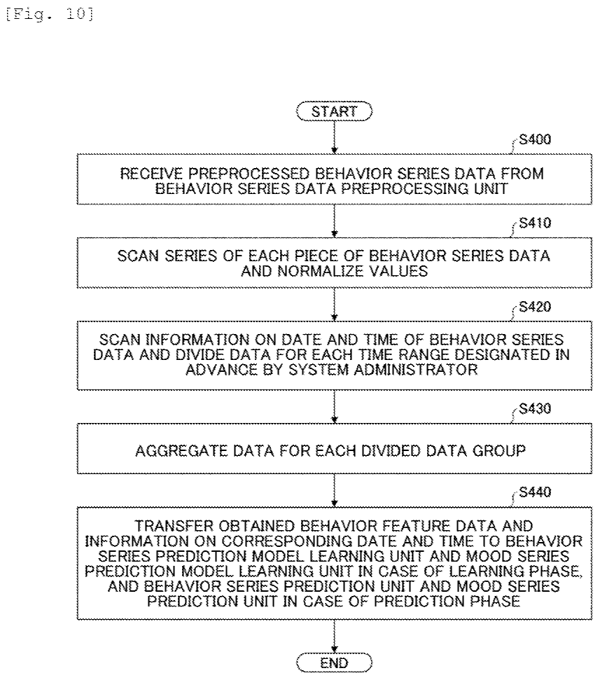

FIG. 10 is a flowchart illustrating an example of a flow of a feature extraction process. The feature extraction process is a process performed by the feature extraction unit 105 in step S110 of the learning process or a process performed by the feature extraction unit 203 in step S210 of the prediction process.

The feature extraction unit 105 or the feature extraction unit 203 receives the preprocessed behavior series data from the behavior data preprocessing unit 201 (step S400).

Next, the feature extraction unit 105 or the feature extraction unit 203 scans the series of each piece of behavior series data and normalizes the values (step S410). For example, the feature extraction unit 105 or the feature extraction unit 203 normalizes the numerical data so that the average is 0 and the standard deviation is 1, and converts the character string type data into a vector of one-hot expression for the corresponding dimension.

Subsequently, the feature extraction unit 105 or the feature extraction unit 203 scans information on the date and time of the behavior series data and divides the data for each time range designated in advance by a system administrator (step S420). For example, in a case where the time range is set to six hours, the feature extraction unit 105 or the feature extraction unit 203 divides the data every six hours.

Next, the feature extraction unit 105 or the feature extraction unit 203 aggregates the data for each divided data group (step S430). For example, the feature extraction unit 105 or the feature extraction unit 203 calculates an average value or a total value for each data group in the case of numerical data. In addition, the feature extraction unit 105 or the feature extraction unit 203 counts the number of occurrences of each dimension to obtain new vector data in the case of vector data of one-hot expression.

In the case of a learning phase, the feature extraction unit 105 transfers the obtained behavior feature data and information on the corresponding date and time to the behavior series prediction model learning unit 107 and the mood series prediction model learning unit 108 (step S440). In the case of a prediction phase, the feature extraction unit 203 transfers the obtained behavior feature data and information on the corresponding date and time to the behavior series prediction unit 205 and the mood series prediction unit 207.

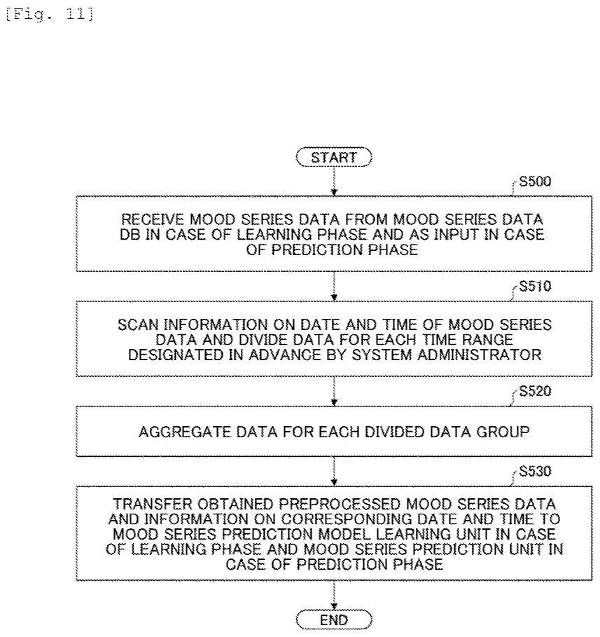

FIG. 11 is a flowchart illustrating an example of a flow of mood data preprocessing. The mood data preprocessing is processing performed by the mood data preprocessing unit 104 in step S120 of the learning process or processing performed by the mood data preprocessing unit 202 in step S230 of the prediction process.

In the case of a learning phase, the mood data preprocessing unit 104 receives the mood series data from the mood series data DB 102 (step S500). Meanwhile, in the case of a prediction phase, the mood data preprocessing unit 202 receives the mood series data as an input.

The mood data preprocessing unit 104 or the mood data preprocessing unit 202 scans the information on the date and time of the mood series data and divides the data for each time range designated in advance by a system administrator (step S510). This time range is the same as the time range set in the feature extraction unit 105 or the feature extraction unit 203.

Subsequently, the mood data preprocessing unit 104 or the mood data preprocessing unit 202 aggregates the data for each divided data group (step S520). For example, the mood data preprocessing unit 104 or the mood data preprocessing unit 202 calculates and stores the average value of Valence and Arousal values. In a case where there is no data in the divided section, the mood data preprocessing unit 104 or the mood data preprocessing unit 202 stores 0 for both Valence and Arousal.

In the case of a learning phase, the mood data preprocessing unit 104 transfers the obtained preprocessed mood series data and information on the corresponding date and time to the mood series prediction model learning unit 108 (step S530). In addition, in the case of a prediction phase, the mood data preprocessing unit 202 transfers the obtained preprocessed mood series data and information on the corresponding date and time to the mood series prediction unit 207.

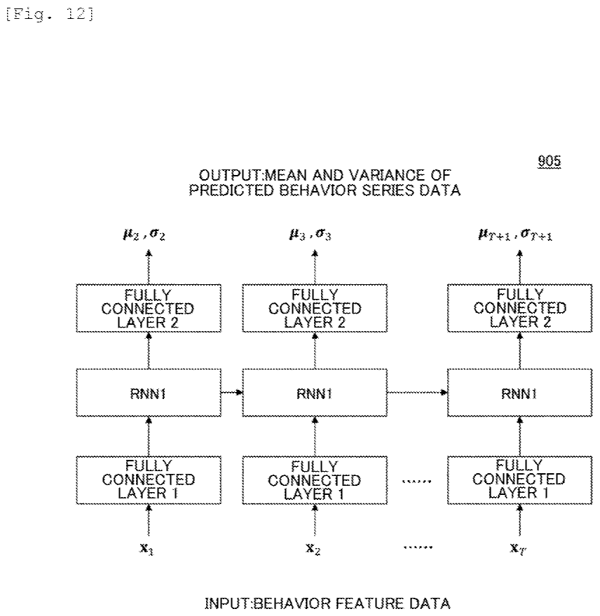

FIG. 12 is a diagram illustrating an example of a behavior series prediction model. Behavior series prediction model 905 is, for example, a deep neural network (DNN) having the following network.

The first network is a fully connected layer 1 that extracts more abstract features from the behavior feature data. The first network transforms the input in the fully connected layer, and then performs nonlinear transformation on the input feature using, for example, a Sigmoid function, a ReLu function, or the like to obtain a feature vector. The first network sequentially repeats this process with respect to behavior feature data given as time-series data.

The second network is an RNN 1 that further abstracts the abstracted feature vector as series data, and is implemented using a known technique such as, for example, a long-short term memory (LSTM). Specifically, the second network sequentially receives series data and repeatedly performs nonlinear transformation while considering past abstracted information.

The third network is a fully connected layer 2 that transforms the feature vector obtained by the RNN 1 into parameters of normal distribution. The third network obtains parameters of mean value and variance corresponding to each piece of input behavior data, and associates output vector data with the mean and variance of each piece of behavior data. That is, the number of dimensions of the vector is the input number of dimensions×2. The third network performs transformation using a Sigmoid function or the like so that the variance is non-negative.

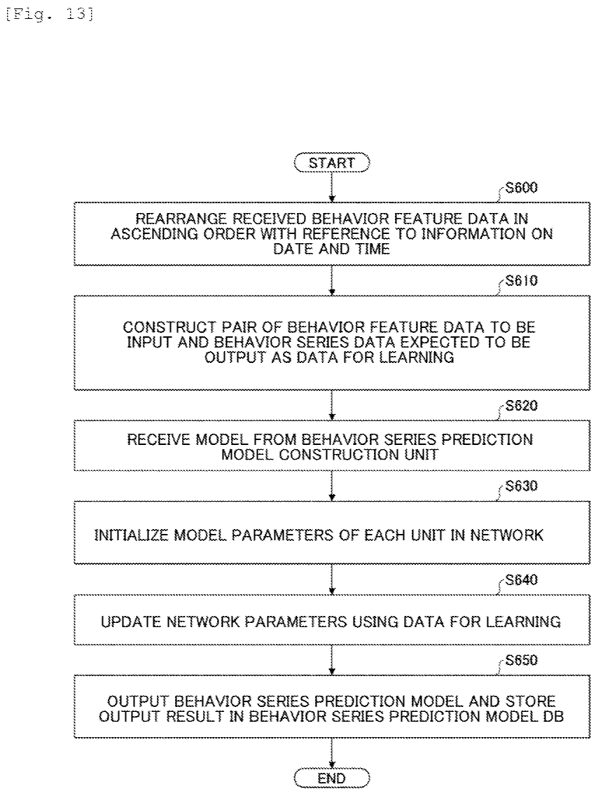

FIG. 13 is a flowchart illustrating an example of a flow of a behavior series prediction model learning process. The behavior series prediction model learning process is a process performed by the behavior series prediction model learning unit 107 in step S140 of the learning process.

The behavior series prediction model learning unit 107 rearranges the received behavior feature data in ascending order with reference to information on a date and time (step S600). Next, the behavior series prediction model learning unit 107 constructs a pair of behavior feature data to be input and behavior series data expected to be output as data for learning (step S610).

Subsequently, the behavior series prediction model learning unit 107 receives the behavior series prediction model from the behavior series prediction model construction unit 106 (step S620). Next, the behavior series prediction model learning unit 107 initializes the model parameters of each unit in the network (step S630). For example, the behavior series prediction model learning unit 107 initializes the parameters with random numbers from 0 to 1.

Subsequently, the behavior series prediction model learning unit 107 updates the parameters of the network using the data for learning (step S640). Specifically, the behavior series prediction model learning unit 107 learns the parameters of the network so that correct behavior series data can be correctly predicted from the input behavior series data. The behavior series prediction model learning unit 107 may calculate the negative log likelihood for the output behavior series data using the mean and variance values obtained in the fully connected layer 2 of the network, and learn the network through the negative log likelihood which is a calculation result using a known technique such as an error back-propagation method. Meanwhile, a normal distribution may be used to calculate the log likelihood.

The behavior series prediction model learning unit 107 then outputs the behavior series prediction model and stores the output result in the behavior series prediction model DB 110 (step S650).

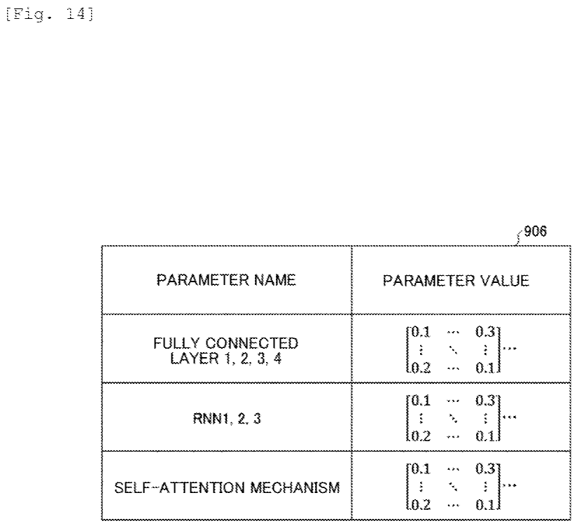

FIG. 14 is a diagram illustrating an example of a behavior series prediction model DB and a mood series prediction model DB. The behavior series prediction model DB and the mood series prediction model DB store parameters in the format of data 906. The data 906 includes a combination of parameters and parameter values.

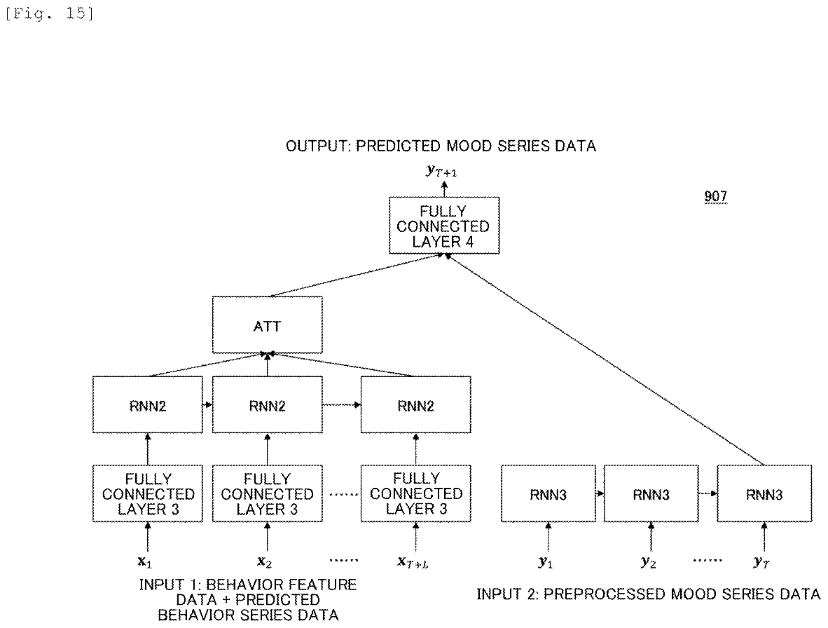

FIG. 15 is a diagram illustrating an example of a mood series prediction model. A mood series prediction model 907 is, for example, a DNN having the following network.

The first network is a fully connected layer 3 that extracts more abstract features from the behavior feature data. The first network performs substantially the same processing as the fully connected layer 1 and obtains a feature vector. The first network sequentially repeats this process with respect to behavior feature data given as time-series data.

The second network is a RNN 2 that further abstracts the abstracted feature vector as series data, and performs processing using a known technique in substantially the same way as the RNN 1 to obtain a feature vector.

The third network is a self-attention mechanism (ATT) that calculates the feature vector considering the importance of each feature vector abstracted by the RNN 1. The weight indicating the importance of each feature vector is realized by two fully connected layers. The third network transforms the feature vector into a context vector of any size in the first fully connected layer, and outputs a scalar value corresponding to the weight with the context vector as an input in the second fully connected layer. The context vector may undergo a nonlinear transformation process. The third network transforms the obtained set of importances into probability values, for example, with a Softmax function or the like. The third network calculates a weighted average of the obtained weight set and feature vector set to obtain a feature vector considering the importance of each feature vector.

The fourth network is a RNN 3 that abstracts the preprocessed mood series data, and performs processing using a known technique in substantially the same way as the RNN 1 to obtain a feature vector.

The fifth network is a fully connected layer 4 that outputs Valence and Arousal of the prediction target time from the feature vectors obtained by the self-attention mechanism and the RNN 3. The fifth network connects the feature vectors obtained by the self-attention mechanism and the RNN 3, and then inputs these feature vectors to the fully connected layer 4 to obtain two-dimensional values corresponding to the values of Valence and Arousal.

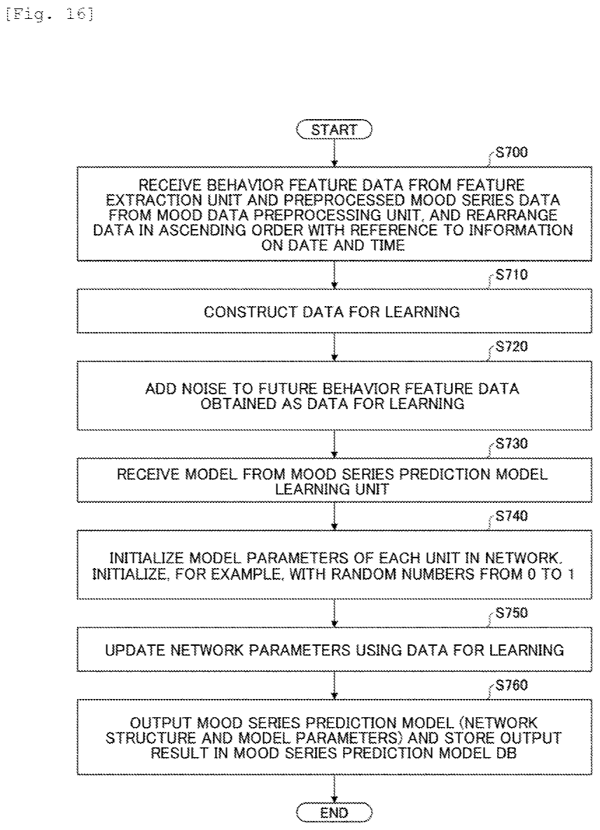

FIG. 16 is a flowchart illustrating an example of a flow of a mood series prediction model learning process. The mood series prediction model learning process is a process performed by the mood series prediction model learning unit 108 in step S160 of the learning process.

The mood series prediction model learning unit 108 receives the behavior feature data from the feature extraction unit 105 and the preprocessed mood series data from the mood data preprocessing unit 104, and rearranges the data in ascending order with reference to the information on a date and time (step S700).

Next, the mood series prediction model learning unit 108 constructs the data for learning (step S710). For example, the mood series prediction model learning unit 108 extracts one piece of certain preprocessed mood series data and uses it as correct data. By referring to the information on the date and time of the preprocessed mood series data, N pieces of preprocessed mood data further in the past than that date and time, N pieces of behavior feature data further in the past than that date and time, and N pieces of behavior feature data further in the future than that date and time are extracted and used as learning data. The mood series prediction model learning unit 108 constructs these three pieces of data as one piece of data for learning. Meanwhile, N is set in advance by a system administrator.

Subsequently, the mood series prediction model learning unit 108 adds noise to the future behavior feature data obtained as data for learning (step S720). Here, the mood series prediction model learning unit 108 prepares a normal distribution with each value of the behavior feature data as the mean and a random number obtained from a gamma distribution having any parameters as the variance, stores values obtained by sampling from the normal distribution as new behavior feature data, and stores random numbers obtained from the gamma distribution as the variance.

Subsequently, the mood series prediction model learning unit 108 receives the model from the mood series prediction model learning unit (step S730).

Next, the mood series prediction model learning unit 108 initializes the model parameters of each unit in the network (step S740). For example, the mood series prediction model learning unit 108 initializes the parameters with random numbers from 0 to 1.

Subsequently, the mood series prediction model learning unit 108 updates the parameters of the network using the data for learning (step S750). Specifically, the mood series prediction model learning unit 108 learns the parameters of the network so that correct mood series data can be correctly predicted from the input mood series data. For example, the mood series prediction model learning unit 108 may use a known error function to calculate the error of the Valence and Arousal prediction results obtained in the fully connected layer 4 of the network with respect to the Valence and Arousal given as correct data, and use the error to learn the network using a known technique such as an error back propagation method.

The mood series prediction model learning unit 108 then outputs a mood series prediction model (network structure and model parameters), and stores the output result in the mood series prediction model DB 111 (step S760).

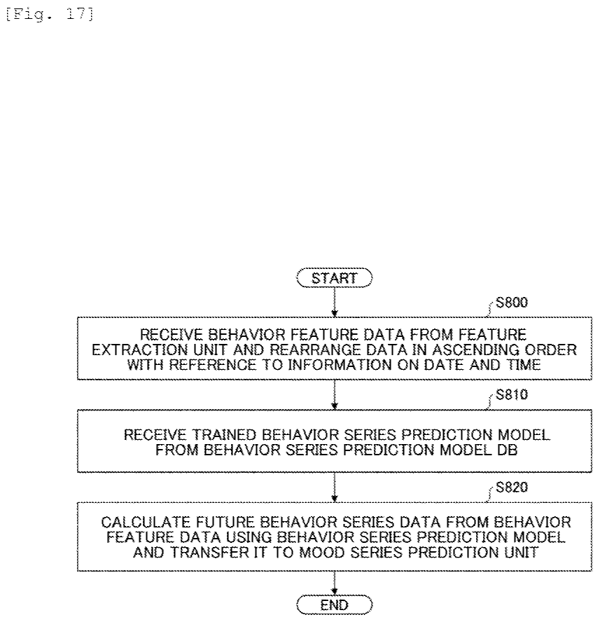

FIG. 17 is a flowchart illustrating an example of a flow of a behavior series prediction process. The behavior series prediction process is a process performed by the behavior series prediction unit 205 in step S220 of the prediction process.

The behavior series prediction unit 205 receives the behavior feature data from the feature extraction unit 203 and rearranges the data in ascending order with reference to the information on a date and time (step S800). Next, the behavior series prediction unit 205 receives the trained behavior series prediction model from the behavior series prediction model DB 204 (step S810).

The behavior series prediction unit 205 then uses the behavior series prediction model to calculate future behavior series data from the behavior feature data, and transfers it to the mood series prediction unit 207 (step S820).

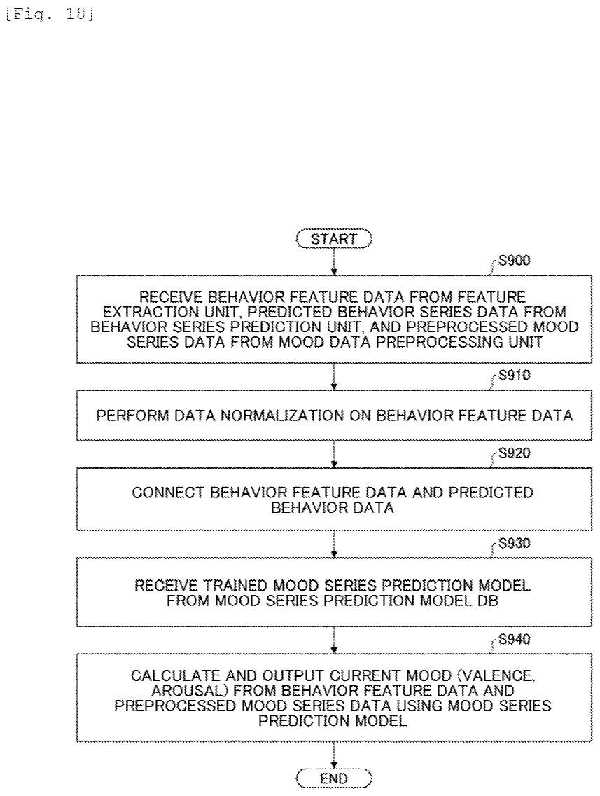

FIG. 18 is a flowchart illustrating an example of a flow of a mood series prediction process. The mood series prediction process is a process performed by the mood series prediction unit 207 in step S240 of the prediction process.

The mood series prediction unit 207 receives the behavior feature data from the feature extraction unit 203, the predicted behavior series data from the behavior series prediction unit 205, and the preprocessed mood series data from the mood data preprocessing unit 202 (step S900).

Next, the mood series prediction unit 207 normalizes the behavior feature data (step S910). For example, the mood series prediction unit 207 stores 0 as the variance value because the mean value and variance value of each behavior correspond to input data of the mood series prediction model but there is no variance value in the behavior feature data. Subsequently, the mood series prediction unit 207 connects the behavior feature data and the predicted behavior series data (step S920). For example, the mood series prediction unit 207 rearranges the behavior feature data in ascending order in accordance with the information on a date and time, connects the behavior series data predicted from the last row in the order of output, and handles the obtained series data as behavior feature data.

Next, the mood series prediction unit 207 receives the trained mood series prediction model from the mood series prediction model DB 206 (step S930).

The mood series prediction unit 207 then uses the mood series prediction model to calculate and output the current mood (Valence, Arousal) from the behavior feature data and the preprocessed mood series data (step S940).

### (Hardware Configuration Example According to the Present Embodiment)

The learning apparatus 10 and the prediction apparatus 20 can be realized, for example, by causing a computer to execute a program describing the processing content described in the present embodiment. Meanwhile, the “computer” may be a physical machine, or may be a virtual machine on the cloud. In a case where a virtual machine is used, “hardware” to be described here is virtual hardware.

The above program can be stored or distributed with the program recorded on a computer readable recording medium (such as a portable memory). In addition, the above program can also be provided through a network such as the Internet or e-mail.

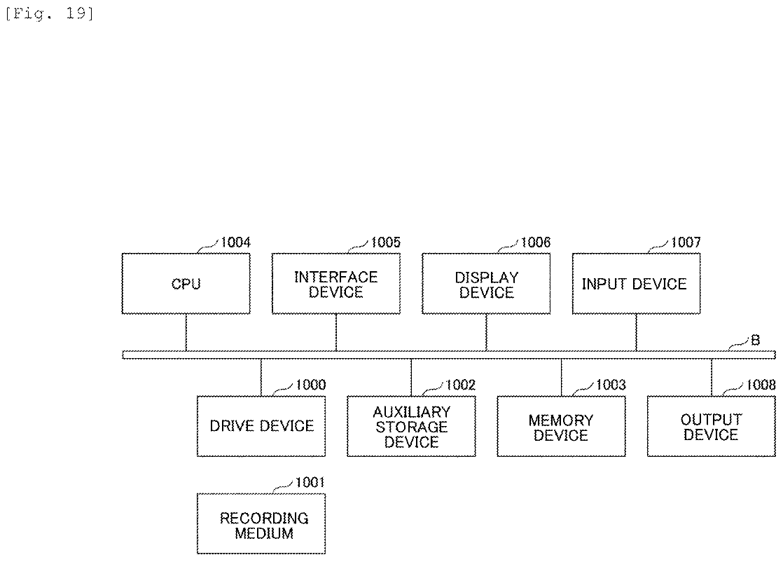

FIG. 19 is a diagram illustrating a hardware configuration example of the above computer. The computer of FIG. 19 has a drive device 1000, an auxiliary storage device 1002, a memory device 1003, a CPU 1004, an interface device 1005, a display device 1006, an input device 1007, an output device 1008, and the like which are connected to each other through a bus B.

A program for realizing processing in the computer is provided by a recording medium 1001 such as, for example, a CD-ROM or a memory card. When the recording medium 1001 having a program stored therein is set in the drive device 1000, the program is installed from the recording medium 1001 through the drive device 1000 to the auxiliary storage device 1002. However, the program does not necessarily have to be installed from the recording medium 1001, and may be downloaded from another computer through a network. The auxiliary storage device 1002 stores the installed program, and stores necessary files, data, or the like.

In response to an activation instruction of a program, the memory device 1003 reads out the program from the auxiliary storage device 1002 and stores the program. The CPU 1004 realizes a function relevant to the device in accordance with the program stored in the memory device 1003. The interface device 1005 is used as an interface for connection to a network. The display device 1006 displays a graphical user interface (GUI) or the like based on the program. The input device 1007 is constituted by a keyboard, a mouse, a button, a touch panel, or the like, and is used for inputting various operation instructions. The output device 1008 outputs arithmetic results. Meanwhile, the above computer may include a graphics processing unit (GPU) or a tensor processing unit (TPU) instead of the CPU 1004, or may include a GPU or a TPU in addition to the CPU 1004. In that case, processing may be divided and executed in such a way that the GPU or the TPU executes processing that requires special arithmetic operations such as, for example, neural networks, and that the CPU 1004 executes other processing.

### REFERENCE DOCUMENT

[1] J. P. Pollak, P. Adams, G. Gay: PAM: A Photographic Affect Meter for Frequent, In Situ Measurement of Affect. In Proc. of CHI, 2011.

### Effects of the Present Embodiment

The learning apparatus 10 according to the present embodiment learns the mood series prediction model by combining the preprocessed behavior data obtained by preprocessing the mood series data, the preprocessed behavior feature data obtained by preprocessing the behavior series data, and the future behavior series obtained from the behavior series prediction model. This makes it possible for the prediction apparatus 20 to predict a mood series of a prediction target that could not be predicted in the related art.

In addition, the learning apparatus 10 predicts future behavior and learns a mood series prediction model using the prediction result as an input. This makes it possible for the prediction apparatus 20 to predict a mood series of a prediction target with a high degree of accuracy.

In addition, the prediction apparatus 20 predicts future behavior as mean and variance, and represents the reliability of the result as variance. The learning apparatus 10 then learns the mood series prediction model with reliability. This makes it possible for the prediction apparatus 20 to predict a mood series with an emphasis on behavior with high reliability.

In addition, it is possible to capture detailed movements in the mood of a prediction target by representing the mood of the prediction target with two-dimensional values of Valence and Arousal.

### Conclusion of Embodiments

The present specification describes at least a prediction apparatus, a learning apparatus, a prediction method, a learning method, and a program which are described in the following paragraphs.

### (Paragraph 1)

A prediction apparatus comprising:
a feature extraction unit configured to extract a feature based on past behavior series data of a prediction target and output behavior feature data;
a behavior series prediction unit configured to predict a future behavior series of the prediction target based on the behavior feature data using a trained behavior series prediction model for predicting a behavior series; and
a mood series prediction unit configured to predict a future mood series of the prediction target based on the behavior feature data and past mood series data of the prediction target using a trained mood series prediction model for predicting a mood series.

### (Paragraph 2)

A learning apparatus comprising:
a feature extraction unit configured to extract a feature based on behavior series data of a learning target and output behavior feature data;
a mood series prediction model construction unit configured to construct a mood series prediction model for predicting a mood series; and
a mood series prediction model learning unit configured to update parameters of the constructed mood series prediction model based on the behavior feature data and past mood series data of the learning target.

### (Paragraph 3)

The learning apparatus according to paragraph 2, wherein the mood series prediction model learning unit updates the parameters based on behavior feature data obtained by adding noise to future behavior feature data extracted as data for learning.

### (Paragraph 4)

The learning apparatus according to paragraph 2 or 3, further comprising:
a behavior series prediction model construction unit configured to construct a behavior series prediction model for predicting a behavior series; and
a behavior series prediction model learning unit configured to update parameters of the behavior series prediction model based on the behavior feature data.

The learning apparatus.

### (Paragraph 5)

The learning apparatus according to paragraph 4, wherein the behavior series prediction model learning unit calculates a negative log likelihood for output behavior series data using values of mean and variance obtained by a network included in the behavior series prediction model and updates the parameters based on a calculation result.

### (Paragraph 6)

A prediction method which is executed by a prediction apparatus, comprising:
a step of extracting a feature based on past behavior series data of a prediction target and outputting behavior feature data;
a step of predicting a future behavior series of the prediction target based on the behavior feature data using a trained behavior series prediction model for predicting a behavior series; and
a step of predicting a future mood series of the prediction target based on the behavior feature data and past mood series data of the prediction target using a trained mood series prediction model for predicting a mood series.

### (Paragraph 7)

A learning method which is executed by a learning apparatus, comprising:
a step of extracting a feature based on behavior series data of a learning target and outputting behavior feature data;
a step of constructing a mood series prediction model for predicting a mood series; and
a step of updating parameters of the constructed mood series prediction model based on the behavior feature data and past mood series data of the learning target.

### (Paragraph 8)

A program for causing a computer to function as each unit in the prediction apparatus according to paragraph 1, or a program for causing a computer to function as each unit in the learning apparatus according to any one of paragraphs 2 to 5.

Hereinbefore, although the present embodiment has been described, the present invention is not limited to such a specific embodiment, and can be modified and changed variously without departing from the scope of the invention described in the appended claims.

### REFERENCE SIGNS LIST

10 Learning apparatus
20 Prediction apparatus
101 Behavior series data DB
102 Mood series data DB
103 Behavior data preprocessing unit
104 Mood data preprocessing unit
105 Feature extraction unit
106 Behavior series prediction model construction unit
107 Behavior series prediction model learning unit
108 Mood series prediction model learning unit
109 Mood series prediction model construction unit
110 Behavior series prediction model DB
111 Mood series prediction model DB
201 Behavior data preprocessing unit
202 Mood data preprocessing unit
203 Feature extraction unit
204 Behavior series prediction model DB
205 Behavior series prediction unit
206 Mood series prediction model DB
207 Mood series prediction unit
1000 Drive device
1001 Recording medium
1002 Auxiliary storage device
1003 Memory device
1004 CPU
1005 Interface device
1006 Display device
1007 Input device
1008 Output device

1. A prediction apparatus comprising:
a memory; and
a processor coupled to the memory and configured to:
extract a feature based on past behavior series data of a prediction target and output behavior feature data;
predict a future behavior series of the prediction target based on the behavior feature data using a trained behavior series prediction model for predicting a behavior series; and
predict a future mood series of the prediction target based on the behavior feature data and past mood series data of the prediction target using a trained mood series prediction model for predicting a mood series.

2. A learning apparatus comprising:
a memory; and
a processor coupled to the memory and configured to:
extract a feature based on behavior series data of a learning target and output behavior feature data;
construct a mood series prediction model for predicting a mood series; and
update parameters of the constructed mood series prediction model based on the behavior feature data and past mood series data of the learning target.

3. The learning apparatus according to claim 2, wherein the processor is configured to update the parameters based on behavior feature data obtained by adding noise to future behavior feature data extracted as data for learning.

4. The learning apparatus according to claim 2, wherein the processor is further configured to:
construct a behavior series prediction model for predicting a behavior series; and
update parameters of the behavior series prediction model based on the behavior feature data.

5. The learning apparatus according to claim 4, wherein the processor is configured to calculate a negative log likelihood for output behavior series data using values of mean and variance obtained by a network included in the behavior series prediction model and update the parameters based on a calculation result.

6. A prediction method which is executed by a prediction apparatus, comprising:
extracting a feature based on past behavior series data of a prediction target and outputting behavior feature data;
predicting a future behavior series of the prediction target based on the behavior feature data using a trained behavior series prediction model for predicting a behavior series; and
predicting a future mood series of the prediction target based on the behavior feature data and past mood series data of the prediction target using a trained mood series prediction model for predicting a mood series.

7. (canceled)

8. A non-transitory computer-readable recording medium storing a program for causing a computer to perform the method of claim 6.
